(19) United States
(12) Patent Application Publication
(10) Pub. No.: US 2026/0057225 A1
(43) Pub. Date: Feb. 26, 2026

(54) Construction method of spatio-temporal neural operator on riemannian manifolds for complex geometries

(71) Applicant: Nanjing University of Aeronautics and Astronautics, Nanjing (CN)

(72) Inventors: Yingguang Li, Nanjing (CN); Xu Liu, Nanjing (CN); Shaochun Sui, Nanjing (CN); Xiaoyang Fu, Nanjing (CN); Gengxiang Chen, Nanjing (CN); Changqing Liu, Nanjing (CN); Xiaozhong Hao, Nanjing (CN)

(73) Assignee: Nanjing University of Aeronautics and Astronautics, Nanjing (CN)

(21) Appl. No.: 19/315,355

(22) Filed: Aug. 29, 2025

(30) Foreign Application Priority Data
Aug. 29, 2024 (CN) 202411198804.7

(51) Int. Cl. G06N 3/049; G06F 17/14

(52) U.S. Cl. CPC G06N 3/049; G06F 17/142

(57) ABSTRACT

A construction method of spatio-temporal neural operator on Riemannian manifolds for complex geometries is disclosed, and relates to the field of machine learning technology, the method comprises the following steps: S1, according to a geometric space of an input spatio-temporal function and an output spatio-temporal function, solving a set of Laplacian eigenfunctions as basis functions, and then constructing a spatial dimension encoding module [symbol] and a spatial dimension decoding module [symbol] ; S2, solving a set of Fourier basis functions, and then constructing a temporal dimension encoding module [symbol] and a temporal dimension decoding module [symbol] ⁻¹; and S3, constructing a Laplace-Fourier nested kernel integration module, and constructing a spatio-temporal neural operator on Riemannian manifolds for complex geometries by serially connecting a plurality of kernel integration modules. The present disclosure adopts the construction method of spatio-temporal neural operator on Riemannian manifolds for complex geometries based on the above steps, and the mapping between two spatio-temporal functions defined on complex geometries is represented by constructing a parameterized model.

### TECHNICAL FIELD

The present disclosure relates to the field of machine learning technology, particularly a construction method of a spatio-temporal neural operator on Riemannian manifolds for complex geometries.

### BACKGROUND

The mapping model between function spaces constructed using deep neural networks is referred to as Neural Operators (NOs) or operator networks. Neural operator networks can construct prediction models independent of the discretization resolution of input features, which can be applied to high-dimensional mapping problems and have potential advantages in spatio-temporal dynamics modeling. They have the ability to transfer solutions among grids, and NOs only need to be trained once for different grids of the same solutions. For the parameters of a new instance, a solution can be obtained only by forward transfer of the network, thus alleviating the main computational issues arising in the neural finite element method.

Among existing NOs, the framework of deep neural operator (DeepONet) utilizes the general approximation theorem to learn the function mapping through the encoded information from the backbone and branch networks. DeepONet can be regarded as a finite-dimensional operator model, which parameterizes the input data point by point, which means that the number of network parameters still depends on the discretization resolution of the input domain. When faced with complex spatio-temporal functions, its branch network has to deal with complex spatial coordinates, and the backbone network needs to extract the spatio-temporal attributes of each spatial node at all moments, making it difficult to learn accurately.

The Fourier neural operator (FNO) transforms a complex function mapping into a low-dimensional mapping in the frequency domain, which greatly reduces the model complexity. Subsequently, variant operator networks such as wavelet neural operators and U-shaped neural operators have been proposed one after another, and they are widely used in spatio-temporal dynamics modeling. Although these operator networks have successful applications in spatio-temporal field prediction problems, Fourier transform or wavelet transform require uniform grid data defined on a rectangular domain. This limitation makes them unsuitable for mapping of spatio-temporal functions on complex geometries.

The neural operator on Riemannian manifolds (NORM) has been recently proposed, which uses the Laplacian eigenfunctions to encode complex geometric information, so as to learn the mapping among function spaces defined on arbitrary complex geometric domains. Although NORM can effectively handle the spatial dimension of functions, it is still a high-dimensional discretization in the temporal dimension.

### SUMMARY

An objective of the present disclosure is to provide a construction method of a spatio-temporal neural operator on Riemannian manifolds for complex geometries. The mapping between two spatio-temporal functions defined on complex geometries is represented by constructing a parameterized model, and the structural complexity of the model is independent of the discretization resolution of the spatio-temporal dimensions.

In order to achieve the above objective, the present disclosure provides a construction method of a spatio-temporal neural operator on Riemannian manifolds for complex geometries, and the steps are as follows:
a construction method of a spatio-temporal neural operator on Riemannian manifolds for complex geometries, the method includes the following steps:
S1, according to a geometry [symbol] of an input spatio-temporal function and an output spatio-temporal function, solving a set of Laplacian eigenfunctions as basis functions, and then constructing a spatial dimension encoding module [symbol] and a spatial dimension decoding module [symbol] ;
S2, solving a set of temporal basis functions, and then constructing a temporal dimension encoding module [symbol] and a temporal dimension decoding module [symbol] ⁻¹;
S3, performing a nested composition on the spatial dimension encoding module [symbol] and the spatial dimension decoding module [symbol] with the temporal dimension encoding module [symbol] and the temporal dimension decoding module [symbol] ⁻¹ to construct a Laplace-Fourier nested kernel integration module, and constructing a spatio-temporal neural operator on Riemannian manifolds for complex geometries by serially connecting a plurality of kernel integration modules.

In some embodiments, in S1, a process of solving the basis function includes:
defining a corresponding Laplacian for complex geometries as follows:

$$Δ = {\partial }^{2} / \partial {x}_{1}^{2} + … + {\partial }^{2} / \partial {x}_{d}^{2} ; \qquad ( 1 )$$

and then constructing a characteristic equation of the Laplacian as follows:

$$- Δ {ϕ}_{i} ( x ) = {λ}_{i} {ϕ}_{i} ( x ) , x ∈ 𝒳 ; \qquad ( 2 )$$

the obtained Laplacian eigenfunction reflecting the frequency domain information of the geometry is as follows:

$${ϕ}_{i} ( x ) = [ {ϕ}_{1} ( x ) , {ϕ}_{2} ( x ) , … , {ϕ}_{n} ( x ) ] , x ∈ 𝒳 . \qquad ( 3 )$$

In some embodiments, in S1, the specific process of constructing the spatial dimension encoding module [symbol] includes: projecting a geometric space where the spatio-temporal function is located onto the frequency domain space spanned by the Laplacian eigenfunction using the Laplacian eigenfunction, and then defining spatial dimension encoding module [symbol] as a spectral decomposition of the geometry where the spatio-temporal function is located on a Laplacian eigenfunction ϕᵢ(x).

In some embodiments, in S1, the specific process of constructing the spatial dimension decoding module [symbol] includes: decoding an encoded spatial frequency domain function from the frequency domain space spanned by the Laplacian eigenfunction to the geometric space where the output function is located using the Laplacian eigenfunction, and then defining the spatial dimension decoding module [symbol] as a spectral reconstruction of the Laplacian eigenfunction ϕᵢ(x) on [symbol] .

In some embodiments, in S2, the specific process of constructing the temporal dimension encoding module [symbol] includes: performing a fast Fourier transform, a wavelet transform or a Laplace transform on a temporal domain of the spatio-temporal function by using a Fourier basis function.

In some embodiments, in S2, the specific process of constructing the temporal dimension decoding module [symbol] ⁻¹ includes: performing an inverse fast Fourier transform, an inverse wavelet transform or an inverse Laplace transform on an encoded temporal frequency domain function.

In some embodiments, in S3, the Laplace-Fourier nested kernel integration module includes the input spatio-temporal function, the spatial dimension mapping encoding module [symbol] , the temporal dimension mapping encoding module [symbol] , the parameterization module, the temporal dimension mapping decoding module [symbol] ⁻¹, the spatial dimension mapping decoding module [symbol] , and the output spatio-temporal function connected in sequence.

In some embodiments, in S3, the Laplace-Fourier nested kernel integration module includes the input spatio-temporal function, the temporal dimension mapping encoding module [symbol] , the spatial dimension mapping encoding module [symbol] , the parameterization module, the spatial dimension mapping decoding module D, the temporal dimension mapping decoding module [symbol] ⁻¹, and the output spatio-temporal function connected in sequence.

Therefore, the present disclosure adopts the construction method of the spatio-temporal neural operator on Riemannian manifolds for complex geometries according to the above steps. This method can learn a parameterized model through paired training data to represent the mapping between two spatio-temporal functions defined on complex geometries, and the structural complexity of the model is independent of the discretization resolution of the spatio-temporal dimensions. Compared with the DeepONet neural operator, the network architecture and parameter complexity of the present disclosure are independent of the discrete resolution of the input domain, and a more accurate prediction can be achieved. Compared with the FNO, the present disclosure can extract and process non-uniform discretised grid node data, and is suitable for mapping spatio-temporal functions in complex geometries. Compared with the NORM, the present disclosure can encode the spatial dimension and the temporal dimension simultaneously, and the learning of mapping between spatio-temporal functions can be achieved.

Further detailed descriptions of the technical scheme of the present disclosure can be found in the accompanying drawings and embodiments.

### BRIEF DESCRIPTION OF THE DRAWINGS

FIG. 1 is a schematic flow diagram of an embodiment of a construction method of a spatio-temporal neural operator on Riemannian manifolds for complex geometries according to the present disclosure;

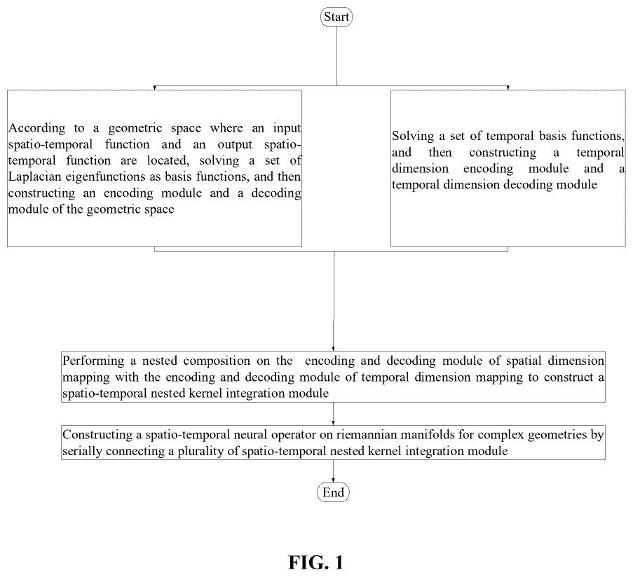

FIG. 2 is a parameter process diagram of a composite part according to an embodiment of the present disclosure;

FIG. 3 is a schematic diagram of a spatio-temporal neural operator on Riemannian manifolds structure according to an embodiment of the present disclosure;

FIG. 4 is a temperature process curve at a single node according to an embodiment of the present disclosure;

FIG. 5 is a comparison diagram between a predicted curing state field distribution and a real curing state field distribution according to an embodiment of the present disclosure;

FIG. 6 is a prediction error statistical diagram according to an embodiment of the present disclosure;

FIG. 7 is a spatio-temporal function of a two-dimensional example and a three-dimensional example according to an embodiment of the present disclosure.

### DETAILED DESCRIPTION OF THE EMBODIMENTS

The technical scheme of the present disclosure is further explained below by drawings and embodiments.

### Embodiment 1

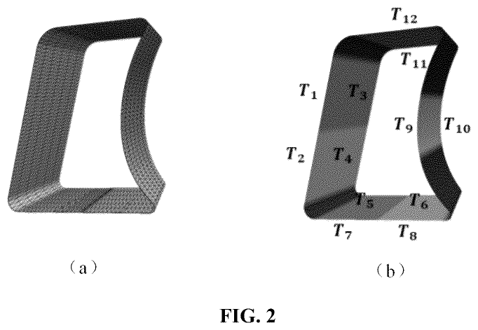

The neural operator network can construct a prediction model independent of the discretization resolution of spatio-temporal features, so it can learn the mapping of high-dimensional spatio-temporal process data to high-dimensional spatio-temporal curing state fields. In the aerospace field, composite parts have the characteristics of large size, complex shape and high precision requirements, so it is crucial to control the deformation of composites during curing. Multi-region self-resistance electric heating is an effective method to control the curing deformation of composites, and the curing stress is compensated by applying different temperature fields in different regions. The composites shown in FIG. 2 serve as an example, the component is a complex closed rotating structure with multiple curved surfaces, and the deformation is large after high-temperature curing.

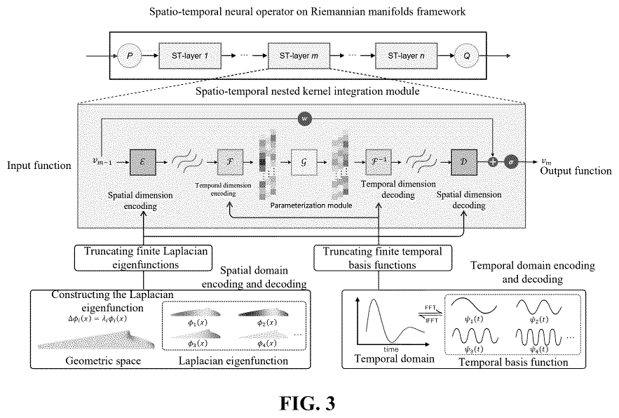

This embodiment aims to quickly and accurately predict the spatio-temporal stress field during component curing to support a large number of iterative optimizations. The method of predicting the spatio-temporal curing state field based on finite element simulation modeling has low computational efficiency and cannot meet a large number of iterative optimization requirements. It is difficult to predict a high-dimensional spatio-temporal curing state field based on a data-driven prediction method. Therefore, in this embodiment, the spatio-temporal process data to the spatio-temporal solidification state field prediction model is established, as shown in FIG. 3. In this model, the input is the spatio-temporal process data of a composite part with a complex shape, and the output is the spatio-temporal curing state field calculated by the spatio-temporal neural operator model. The establishment process is as follows:

S1, according to the geometry [symbol] of the input spatio-temporal function a(x, t),x∈ [symbol] and the output spatio-temporal function u(x, t),x∈ [symbol] , where x represents a position vector, t represents a time, the set of Laplacian eigenfunctions is solved as basis functions.

As shown in FIG. 2 (a), 2,149 grid nodes are divided on the composite parts, and the corresponding Laplacian is defined according to the divided grid type (regular tetrahedral grid):

$$Δ = {\partial }^{2} / \partial {x}_{1}^{2} + … + {\partial }^{2} / \partial {x}_{d}^{2} ; \qquad ( 1 )$$

and then the characteristic equation of the Laplacian is constructed as follows:

$$- Δ {ϕ}_{i} ( x ) = {λ}_{i} {ϕ}_{i} ( x ) , x ∈ 𝒳 ; \qquad ( 2 )$$

the obtained Laplacian eigenfunction reflecting the frequency domain information of the geometry is as follows:

$${ϕ}_{i} ( x ) = [ {ϕ}_{1} ( x ) , {ϕ}_{2} ( x ) , … , {ϕ}_{n} ( x ) ] , x ∈ 𝒳 . \qquad ( 3 )$$

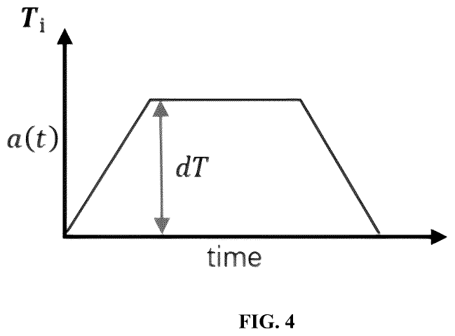

As shown in FIG. 2 (b), the spatio-temporal process parameters are input, specifically for the temperature process curve of composite parts that are randomly set in different regions. FIG. 4 shows the temperature process curves at a single node. The holding temperature of all regions is randomly generated between 413-433 K, and other parameters remain unchanged. The curing state on the divided grid nodes is sampled in the time process to obtain a set of frequency domain orthogonal basis functions in the Fourier domain:

$$[ {ψ}_{1} ( x ) , {ψ}_{2} ( x ) , … , {ψ}_{m} ( x ) ] .$$

The spatio-temporal curing process data xᵢ, i=1, . . . , N in 1,000 sets of curing cycles and the spatio-temporal curing state field data yᵢ reflecting the evolution of the curing state during the curing process of parts under each xᵢ are sampled to form N sets of spatio-temporal data pairs {(xᵢ, yᵢ)|i=1, . . . , N}.

The spatial domain feature of the spatio-temporal function is projected onto the frequency domain space spanned by the Laplacian eigenfunction using the Laplacian eigenfunction, and then the spatial dimension encoding module [symbol] is defined as the spectral decomposition of the spatial domain feature of the spatio-temporal function on the Laplacian eigenfunction uᵢ(x), and is obtained as follows:

$$ε : ( X , 𝒯 ; ℝ ) \to ( {ℒ}_{𝒳} , 𝒯 ; ℝ ) , ε ( v ) := ( 〈 v , {u}_{1} ( x ) 〉 , … , 〈 v , {u}_{n} ( x ) 〉 ) , ∀ v ∈ Ω \qquad ( 4 )$$

in the formula, [symbol] is the space where the geometric features of the input complex shape parts are located, [symbol] is the space where the temporal dimension features are located, and [symbol] is the frequency domain space spanned by the Laplacian eigenfunction, v can be regarded as the vector of time attributes on the space node, v is the spatial domain feature of the spatio-temporal function, and [symbol] is the function value domain space.

The encoded spatial frequency domain function is decoded from the frequency domain space spanned by the Laplacian eigenfunction to the complex geometric space using the Laplacian eigenfunction, and then the spatial dimension decoding module [symbol] is defined as the spectral reconstruction of the Laplacian eigenfunction uᵢ(x) on the complex geometry, and is obtained as follows:

$$𝒟 : ( {ℒ}_{𝒳} , 𝒯 ; ℝ ) \to ( 𝒳 , 𝒯 ; ℝ ) , v = 𝒟 ( β ) = {\sum }_{i = 1}^{N} {β}_{i} {u}_{𝔦} ( x ) , ∀ β ∈ ℝ \qquad ( 5 )$$

in the formula, β is the encoded spatial frequency domain function.

S2, the Fourier basis function is used to project the temporal domain features of the spatio-temporal function into the Fourier domain spanned by the Fourier basis function, and then the temporal dimension encoding module [symbol] is defined as the spectral decomposition of the temporal domain features of the spatio-temporal function on the Fourier basis function, and is obtained as follows:

$$ℱ : ( {ℒ}_{𝒳} , 𝒯 ; ℝ ) \to ( {ℒ}_{𝒳} , {ℒ}_{𝒯} ; ℂ ) , F ( l ) := ( 〈 l , {ψ}_{1} ( x ) 〉 , … , ( l , {ψ}_{m} ( x ) 〉 ) , ∀ l ∈ ℝ \qquad ( 6 )$$

where [symbol] is the frequency domain space spanned by the Fourier basis function, the input l is the temporal domain feature of the spatio-temporal function, [symbol] is the function value domain space, and ψᵢ(x) is the Fourier basis function.

The encoded temporal frequency domain function is decoded from the frequency domain space spanned by the Fourier basis function to the temporal domain, and then the temporal dimension decoding module [symbol] ⁻¹ is defined as the spectral reconstruction of the Fourier basis function in the temporal domain [symbol] , and is obtained as follows:

$${ℱ}^{- 1} : ( {ℒ}_{𝒳} , {ℒ}_{𝒯} ; ℂ ) \to ( {ℒ}_{𝒳} , 𝒯 ; ℂ ) , {ℱ}^{- 1} ( γ ) = {\sum }_{i = 1}^{m} {γ}_{i} {ψ}_{i} ( x ) , ∀ γ ∈ ℂ \qquad ( 7 )$$

where γ is the encoded temporal frequency domain function.

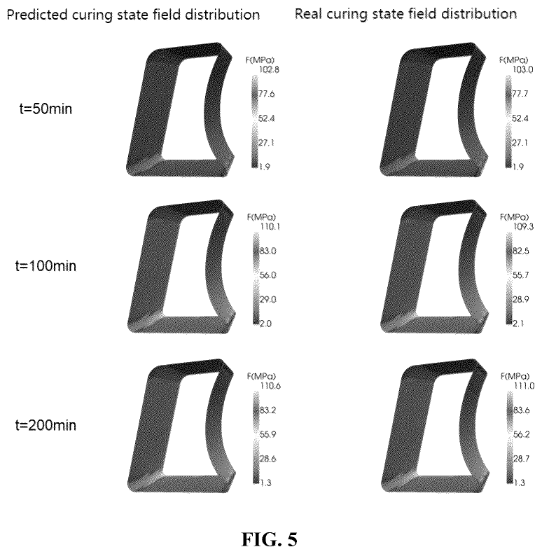

The spatio-temporal data samples {(xᵢ, yᵢ)|i=1, . . . , N} are used to train the model parameters, so as to obtain the spatio-temporal curing state field prediction model of composite parts. The comparison between the predicted curing state field distribution and the real curing state field distribution is shown in FIG. 5. The resulting spatio-temporal neural operator on Riemannian manifolds structure containing the Laplace kernel integral module and the Fourier kernel integral module is shown in FIG. 3.

In this embodiment, 1,000 sets of spatio-temporal data obtained from the sampling are used as the training set, and 200 sets of spatio-temporal data are used as the test set. The model parameters of the neural operator are learned by minimizing the loss function using the gradient descent method. The loss function is defined as follows:

$$Loss = \frac{1}{N} {\sum }_{n = 1}^{N} \frac{{\vert {y}_{i} - {y}_{p i} ‖}_{{L}^{2}}}{{‖ {y}_{i} ‖}_{{L}^{2}}} \qquad ( 8 )$$

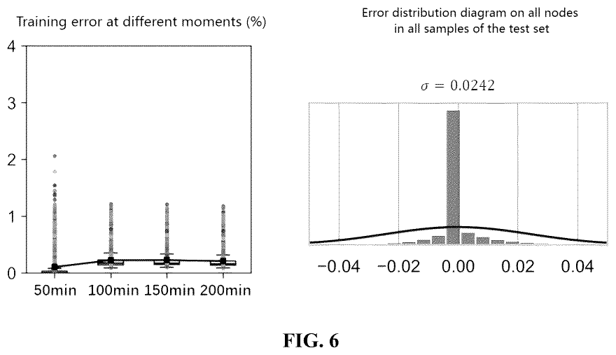

In this embodiment, the learning rate is set to 0.01, the attenuation is 0.5 per 200 iterations, the number of iterations is 1000, the batch size is 50, and the Adam iterative optimizer is used. FIG. 6 (a) is the statistical diagram of the errors of all grid nodes at different moments. It can be seen from the diagram that the average relative error at each moment is lower than 0.5%. FIG. 6 (b) is the error distribution diagram on all nodes in all samples of the test set. The prediction error distribution of this method presents the Gaussian distribution with a 0 mean value, and the prediction standard deviation is 0.0242. It can be seen that the method of this embodiment can be more accurate in achieving the prediction of the spatio-temporal curing state field of composite parts.

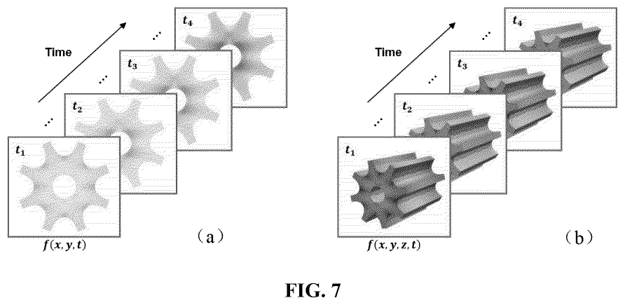

The spatio-temporal neural operator on Riemannian manifolds proposed in this application can be applied to the evolution of spatio-temporal functions of many complex geometries, such as the flow velocity field of fluid in elbows, the deformation field during the machining of aircraft structural parts, etc. FIG. 7 (a) represents the spatio-temporal function of the two-dimensional example, which can be expressed as ƒ(x, y, t); FIG. 7 (b) represents the spatio-temporal function of the three-dimensional example, which can be expressed as ƒ(x, y, z, t). For most engineering problems, the spatio-temporal function ƒ is a scalar function with a specific physical meaning.

Finally, it should be noted that the above embodiments are merely used for describing the technical solutions of the present disclosure, rather than limiting the same. Although the present disclosure has been described in detail with reference to the preferred examples, those of ordinary skill in the art should understand that the technical solutions of the present disclosure may still be modified or equivalently replaced. However, these modifications or substitutions should not make the modified technical solutions deviate from the spirit and scope of the technical solutions of the present disclosure.

What is claimed is:

1. A construction method of spatio-temporal neural operators on Riemannian manifolds for complex geometries, comprising the following steps:
S1, according to a geometry [symbol] of an input spatio-temporal function and an output spatio-temporal function, solving a set of Laplacian eigenfunctions as basis functions, and then constructing a spatial dimension encoding module [symbol] and a spatial dimension decoding module [symbol] ;
S2, solving a set of temporal basis functions, and then constructing a temporal dimension encoding module [symbol] and a temporal dimension decoding module [symbol] ⁻¹; and
S3, performing a nested composition on the spatial dimension encoding module [symbol] and the spatial dimension decoding module [symbol] with the temporal dimension encoding module [symbol] and the temporal dimension decoding module [symbol] ⁻¹ to construct a Laplace-Fourier nested kernel integration module, and constructing a spatio-temporal neural operator on Riemannian manifolds for complex geometries by serially connecting a plurality of kernel integration modules; wherein the complex geometries are composite parts with complex shapes;
wherein in S1, a process of solving the basis function comprises:
defining a corresponding Laplacian for complex geometries as follows:
$$Δ = {\partial }^{2} / \partial {x}_{1}^{2} + … + {\partial }^{2} / \partial {x}_{d}^{2} ; \qquad ( 1 )$$
and then constructing a characteristic equation of the Laplacian as follows:
$$- Δ {ϕ}_{i} ( x ) = {λ}_{i} {ϕ}_{i} ( x ) , x ∈ 𝒳 ; \qquad ( 2 )$$
wherein the obtained Laplacian eigenfunction reflecting frequency domain geometry information is as follows:
$${ϕ}_{i} ( x ) = [ {ϕ}_{1} ( x ) , {ϕ}_{2} ( x ) , … , {ϕ}_{n} ( x ) ] , x ∈ 𝒳 ; \qquad ( 3 )$$
wherein in S1, the specific process of constructing the spatial dimension encoding module [symbol] comprises: projecting a geometric space where the spatio-temporal function is projected onto the frequency domain space spanned by the Laplacian eigenfunction using the Laplacian eigenfunction, and then defining a spatial dimension encoding module ε as a spectral decomposition of the geometry where the spatio-temporal function is located on a Laplacian eigenfunction φᵢ(x);
wherein in S1, the specific process of constructing the spatial dimension decoding module [symbol] comrpises: decoding an encoded spatial frequency domain function from the frequency domain space spanned by the Laplacian eigenfunction to the geometric space where the output function is located using the Laplacian eigenfunction, and then defining the spatial dimension decoding module [symbol] as a spectral reconstruction of the Laplacian eigenfunction φᵢ(x) on [symbol] ;
wherein in S2, the specific process of constructing the temporal dimension encoding module [symbol] comprises: performing a fast Fourier transform, a wavelet transform or a Laplace transform on a temporal domain of the spatio-temporal function by using a Fourier basis function;
wherein in S2, the specific process of constructing the temporal dimension decoding module [symbol] ⁻¹ comprises: performing an inverse fast Fourier transform, an inverse wavelet transform or an inverse Laplace transform on an encoded temporal frequency domain function;
wherein in S3, the Laplace-Fourier nested kernel integration module comprises the input spatio-temporal function, the spatial dimension mapping encoding module ε, the temporal dimension mapping encoding module [symbol] , the parameterization module, the temporal dimension mapping decoding module [symbol] ⁻¹, the spatial dimension mapping decoding module [symbol] , and the output spatio-temporal function connected in sequence.

2. The construction method of spatio-temporal neural operator on Riemannian manifolds for complex geometries according to claim 1, wherein in S3, the Laplace-Fourier nested kernel integration module comprises the input spatio-temporal function, the temporal dimension mapping encoding module [symbol] , the spatial dimension mapping encoding module [symbol] , the parameterization module, the spatial dimension mapping decoding module [symbol] , the temporal dimension mapping decoding module [symbol] ⁻¹, and the output spatio-temporal function connected in sequence.
